(19) United States
(12) Patent Application Publication
(10) Pub. No.: US 2007/0221813 A1
(43) Pub. Date: Sep. 27, 2007

(54) Service trolley for a hair salon

(76) Inventors: Thorsten Blum, Darmstadt (DE); Tobias Stahle, Pfungstadt (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/705,685

(22) Filed: Feb. 12, 2007

(30) Foreign Application Priority Data
Feb. 13, 2006 (EP) 06002804.0

(51) Int. Cl. F16M 13/00

(52) U.S. Cl. 248/520

(57) ABSTRACT

A service trolley (1) having a pedestal (2) on which rollers (3) are provided for moving the service trolley (1) and having at least one holding surface (4, 5, 23, 25) on a support beam (6) is provided for use in a hair salon. In order to be able to carry out a dust-free production of hair coloring right next to the hairdresser's customer, it is proposed that a holding surface (4) has a device (7) for holding granulate (8) for hair coloring purposes. The granulate (8) can be dosed in a simple manner and also can still be used after longer periods of storage.

### FIELD OF THE INVENTION

The subject of the application relates to a service trolley for use in a hair salon having a pedestal on which rollers for moving the service trolley are provided and having at least one holding surface on a support beam of the service trolley.

### BACKGROUND

Service trolleys of this type are known in widely varying designs. They are used in hair salons for holding technical supplies for hairdressers. Among these supplies are scissors, electric trimmers, hair dryers, shampoos, hair spray containers, and other items.

If a particular hair color is desired in a hair salon, the hairdresser has basically two possibilities for providing it. He can use a dye cream that corresponds to the desired hair color. In so doing, he can also mix different dye creams. However, the use of dye creams has the disadvantage that an opened tube with dye cream can only be preserved relatively briefly. Moreover, depending on the length of the hair to be colored, a lesser or greater amount of dye cream is left over. This leftover amount often cannot be reused and therefore becomes waste.

Alternatively, a hairdresser can use a dye powder in order to produce a hair color. He can also mix different dye powders in order to produce a mixed tone. Leftover dye powder can clearly be kept longer than a dye cream that is in an already opened tube. However, a dye powder has the disadvantage that it generates dust. This dust should not be inhaled. As a result, using the dye powder without caution for hairdresser and customer is not acceptable.

The object of the present invention is to design a service trolley of the type described at the outset in such a manner that a hair color can be produced right next to a hairdresser's customer.

### SUMMARY OF THE INVENTION

The present invention relates to a service trolley i for use in a hairdresser salon having a pedestal 2, on which rollers 3 are provided for moving the service trolley 1, and having at least one holding surface 4, 5, 23, 25 on a support beam 6 of the service trolley 1, wherein a holding surface 4 has a device 7 for holding granulate 8 for hair coloring purposes.

### DETAILED DESCRIPTION

The proposed invention has the advantage that it is possible to produce a hair color right next to a hairdresser's customer, because the service trolley can be pushed up to the customer. While the hair color is being produced, no dust is generated because the granulate, which contains, e.g., a base hair coloring component, does not produce dust. Moreover, the granulate may be extracted in any desired amount. Leftover granulate may be used to produce additional color for a relatively long time.

The device has a plurality of dispensers, and a granulate for coloring hair is provided in each dispenser; so, a hair color can be prepared in a simple manner just by using the corresponding dispensers. By drawing granulate from different dispensers, a mixed color can thereby be produced. In this context, it is advantageous if all of the dispensers can be used with one hand. Located in each dispenser is, for example, a granulate for a different base color. However, a granulate mixture for a particular target color could also be provided in each dispenser.

A very high degree of user-friendliness is achieved if the device has a plurality of recesses in each of which a dispenser is provided for dispensing one color component of a hair color. A hairdresser selects one or more dispensers and draws an appropriate amount of granulate from each. The dispensers are easily within reach if they are inserted into the recesses upside down.

The dispenser has a reservoir for holding granulate and a dispensing head having a discharge opening; so, the dispenser can grasped in a simple manner on its reservoir and stood upside down, that is, with its dispensing head downward, in order to dispense a granulate, especially into a measuring cup. It is very advantageous if recesses for holding the dispensing heads are sized in such a manner that the dispensing heads can easily be pulled out of them and reinserted. Taking them out is easy to implement if a dispensing head has an actuator device for delivering the granulate. Moreover, if the actuator device is a push button, then a dispenser can comfortably be used with one hand.

A complete coloring station is achieved if a bottle with peroxide and a container that holds a cream hair color without dye are provided on the holding surface or surfaces of the service trolley. Then a reactive hair color can be mixed on a hairdresser's customer for which granulate with dye, peroxide, and a cream hair color without dye are needed.

For coloring strands of hair, it is advantageous if a strand foil is available within reach on the service trolley in that a roll of strand foil is provided on the holding surface or on the support beam.

A scale on the service trolley is used for gravimetric determination of granulate masses. Using a measuring cup, the granulate masses are instead volumetrically determined.

The overall holding surface can be enlarged or reduced as needed if a hinge is provided on a holding surface, and a tray that has an additional holding surface and swivels about the hinge is connected to the holding surface via the hinge. In this way the additional holding surface of the tray can be used by swinging in place the tray, and by swinging the tray away, especially beneath the holding surface that has the hinge, it is brought into a storage position.

If at least one recess or one cutout is provided in the holding surface for holding the device, a scale, a measuring cup, a brush, or a tint bowl, these utensils can each be securely held in the recess or cutout. This is especially advantageous if the service trolley is moved. For them to be securely held, it is necessary for the recesses or cutouts to be adapted in their dimensions to the articles to be held. Therefore, the walls of the recesses or cutouts hold a bottom area of an article, or, if an article sticks through a cutout, they hold this article.

The proposed service trolley is described below with reference to figures that depict an exemplary embodiment.

The following is shown:

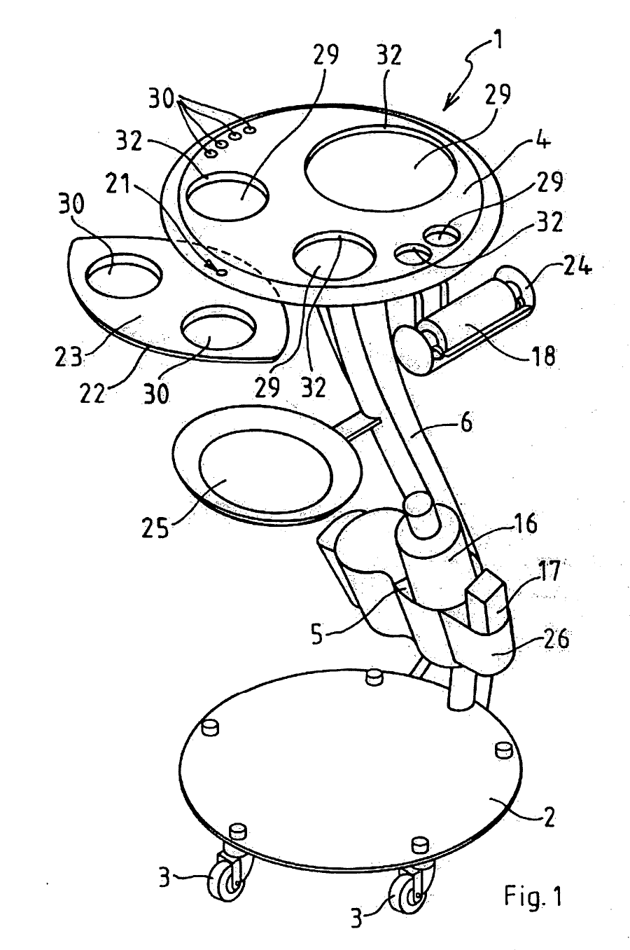

FIG. 1 in a perspective view, a service trolley for use in a hair salon;

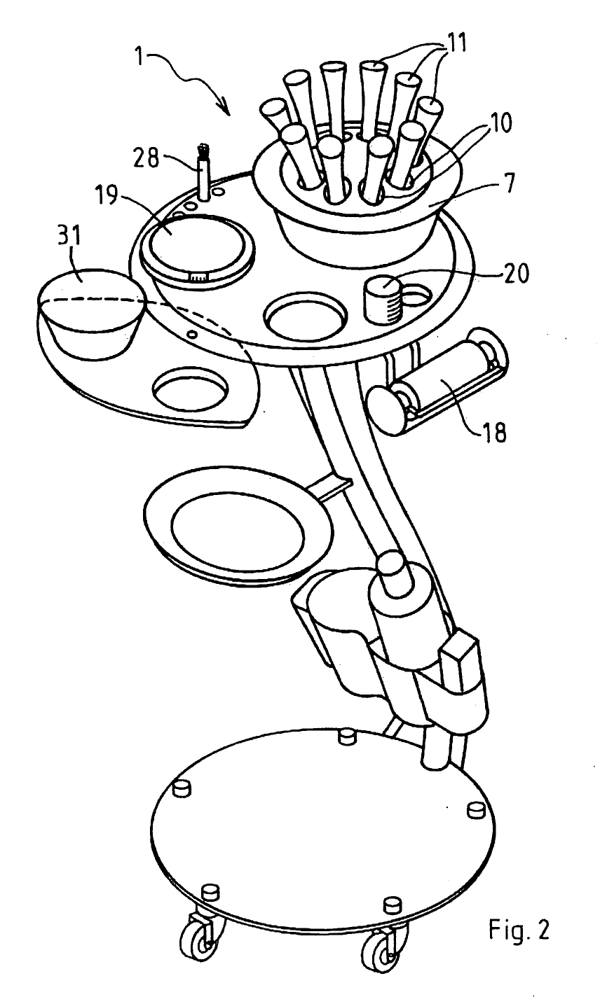

FIG. 2 in a perspective view, the service trolley of FIG. 1, but also having a device that has a plurality of dispensers for dispensing granulate for coloring hair and having additional hairdresser utensils; and

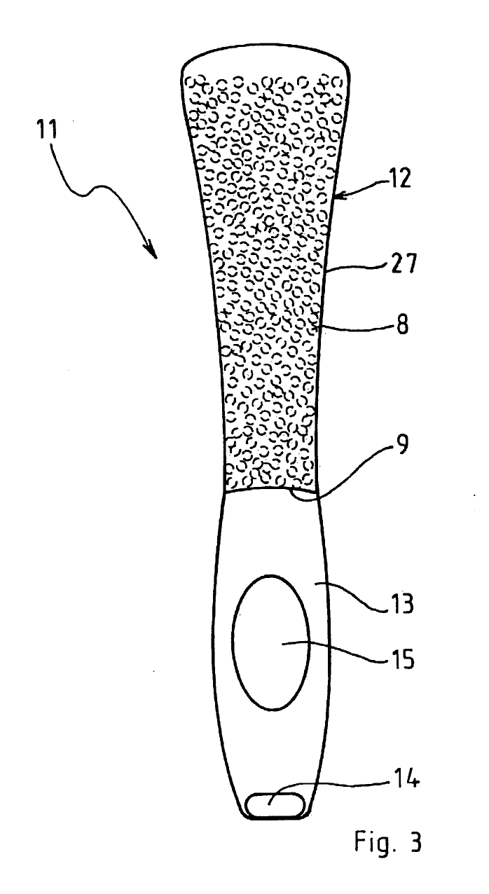

FIG. 3 in a side view a dispenser according to FIG. 2 that has a transparent reservoir and a dispensing head with a push button.

A service trolley 1 is for use in a hair salon. It has a pedestal 2 on which rollers 3 are provided for movement of the service trolley 1 and four holding surfaces 4, 5, 23, 25. All holding surfaces 4, 5, 23, 25 are supported by a support beam 6 of the service trolley 1. A holding surface 4 has a device 7 for holding granulate 8 for hair coloring purposes.

Device 7 has a plurality of dispensers 11. In each dispenser 11, a granulate 8 for coloring hair is provided. A plurality of recesses 10, in each of which a dispenser 11 for dispensing a color component for hair coloring is inserted upside down, is formed in the device 7. Each dispenser 11 has a reservoir 12 provided with a transparent wall 27 for holding granulate 8 and a dispensing head 13 having a dispensing opening 14 and being joined via a screw connection 9 to the reservoir 12. On dispensing head 13, an actuating device 15 configured as a push button is used to discharge granulate 8.

On a holding surface 5, which is provided with a wall 26, are a bottle 16 containing hydrogen peroxide and a container 17 containing a cream hair color without dye.

Attached to a plate, which has a holding surface 4, is a roll holder 24 that holds a roll 18 of strand foil. The strand foil is needed for wrapping each strand of hair that is wetted with a reactive hair color.

Provided in the area of the uppermost holding surface 4 is a hinge 21. A tray 22 that swings about hinge 21 and has holding surface 23 is joined via hinge 21 to holding surface 4 and optionally can be swung beneath the plate that forms top holding surface 4. Contained in holding surfaces 4, 23 are on the one hand recesses 29 with borders 32 and on the other hand cutouts 30. These are formed for holding device 7, a scale 19, a measuring cup 20, a brush 28, and a tinting bowl 31.

A hairdresser first pushes the service trolley up to a customer sitting at the treatment station. He places tinting bowl 31 on scale 19, tares scale 19 and then selects a specific quantity of granulate 8 of a base hair color from each of three specific dispensers 11. These three amounts of granulate 8 are dispensed directly into tinting bowl 31 in order to provide three base colors for a mixed hair color to be achieved (target color). The granulate mixture is then mixed with a specific volume of peroxide that is measured in a measuring cup 20 and a bead of specific length from a tube that is drawn from container 17. After stirring these products in tinting bowl 31, the hair coloring mixture that is then reactive is applied to the customer's hair strands using a brush 28.

As a possibility for alternative use a trolley according to the present invention can also be used with color mixing materials provided in powder, paste or liquid form provided useful and satisfactory ways are found to overcome the problems associated with their current form of presentation.

### LIST OF REFERENCE NUMBERS:

1 Service trolley

2 Pedestal

3 Roller

4, 5 Holding surface

6 Support beam

7 Device for holding granulate

8 Granulate

9 Screw connection

10 Recess

11 Dispenser

12 Reservoir

13 Dispensing head

14 Discharge opening

15 Actuator device

16 Bottle

17 Container

18 Roller

19 Scale

20 Measuring cup

21 Hinge

22 Tray

23 Holding surface

24 Roll holder

25 Storage location

26 Wall

27 Wall, transparent

28 Brush

29 Recess

30 Cutout

31 Tinting bowl

32 Border

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A service trolley for use in a hairdresser salon having a pedestal, on which rollers are provided for moving the service trolley, and comprising at least one holding surface on a support beam of the service trolley, wherein a holding surface comprises a device for holding granulate for hair coloring purposes.

2. A service trolley according to claim 1, wherein the device comprises a plurality of dispensers, and in each dispenser a granulate for coloring hair is provided.

3. A service trolley according to claim 2, wherein the device comprises a plurality of recesses in each of which a dispenser for the dispensing of a color component for a hair color is provided.

4. A service trolley according to claim 3, wherein the dispenser comprises a reservoir for holding granulate and a dispensing head connected to the reservoir with a dispensing opening.

5. A service trolley according to claim 4, wherein the dispensing head comprises an actuator device for discharging the granulate.

6. A service trolley according to claim 2, wherein a bottle with peroxide and a container comprises a dye-free cream hair color are provided on the holding surface or surfaces.

7. A service trolley according to claim 2, wherein a roll of strand foil is provided on a holding surface.

8. A service trolley according to claim 2, wherein a scale is provided on the service trolley.

9. A service trolley according to claim 1, wherein at least one measuring cup is provided on the service trolley.

10. A service trolley according to claim 1, wherein a tray that swivels about a hinge and comprises an additional holding surface is joined via the hinge to the holding surface.

11. A service trolley according to claim 1, wherein at least one recess or one cutout is provided in the storage surfaces for holding the device, a scale, a measuring cup, a brush, or a tinting bowl.
